(19) United States
(12) Patent Application Publication
(10) Pub. No.: US 2009/0061069 A1
(43) Pub. Date: Mar. 5, 2009

(54) High Protein Caramel Flavored Confection

(75) Inventors: Melvin O. Warnecke, Goodlettesville/Ridgetop, TN (US); Bryan D. Lewis, Murfreesboro, TN (US); Anthony Olberding, Bloomington Springs, TN (US); Kimberly Brooks, Nashville, TN (US)

Correspondence Address: FROST BROWN TODD, LLC, 2200 PNC CENTER, 201 E. FIFTH STREET, CINCINNATI, OH, 45202, US

(73) Assignee: The Standard Candy Company, Inc., Nashville, TN (US)

(21) Appl. No.: 11/850,232

(22) Filed: Sep. 5, 2007

(51) Int. Cl. A23G 3/52; A23G 3/44; A23L 1/09

(52) U.S. Cl. 426/656; 426/657; 426/572

(57) ABSTRACT

A caramel flavored confection with high protein content, and methods for making the confection.

### BACKGROUND OF THE INVENTION

The present invention relates, in general, to a caramel flavored confection that contains a high amount of protein.

Nutritional sports bars are designed to deliver vitamins, minerals, protein, and carbohydrate supplements. The taste and consistency of the bar depends on the ingredients, which also determine the amounts of each of the supplements that can be incorporated.

One of the problems associated with preparing acceptable caramel flavored nutritional sports bars is the lack of a caramel flavored ingredient with high protein. Caramel has a relatively low protein content, so a nutritional bar containing a large amount of caramel would necessarily be low in protein.

Consequently, a significant need exists for a caramel flavored confection that contains a high amount of protein with excellent taste and texture.

### BRIEF SUMMARY OF THE INVENTION

The invention overcomes the above-noted and other deficiencies by providing a caramel flavored confection that contains a high amount of protein.

One embodiment is a caramel flavored confection comprising from about 12% to about 50% protein and less than 10% fat, wherein at least one-third of the caramel flavored confection was cooked at a temperature not less than about 110° C.

Another embodiment is a caramel flavored confection comprising from about 12% to about 50% protein and greater than 5% water, wherein at least one-third of the caramel flavored confection was cooked at a temperature not less than about 110° C.

Another embodiment is a method of making a caramel flavored confection, comprising the steps of: homogenizing a mixture of water and sugar; cooking the homogenized mixture; and mixing protein into the cooked mixture; wherein at least one-third of the caramel flavored confection is cooked at a temperature of not less than 110° C.

These and other objects and advantages of the present invention shall be made apparent from the description.

### DETAILED DESCRIPTION OF THE INVENTION

As used herein, a caramel flavored confection is formed using the Maillard reaction, Caramelization reaction, or both. The Maillard reaction is between amino groups in protein and a reducing sugar, while the Caramelization reaction is between sugars and does not involve amino groups. These reactions typically occur when the appropriate ingredients are heated. The Maillard and Caramelization reactions contribute to the flavor and color attributes of the caramel flavored confection. The caramel flavored confection may be used as an ingredient in a food, candy, or nutritional bar; or may be a food, candy, or nutritional bar itself. The caramel flavored confection may be a caramel, taffy, or nougat. Other ingredients may be mixed into the caramel flavored confection.

One embodiment of the caramel flavored confection comprises from about 12% to about 50% protein and less than 10% fat, wherein at least one-third of the caramel flavored confection was cooked at a temperature not less than about 110° C. The caramel flavored confection may comprise from about 20% to about 50% protein, or from about 28% to about 33% protein. The caramel flavored confection may comprise from about 3% to less than 10% fat.

In another embodiment, the caramel flavored confection comprises from about 12% to about 50% protein and greater than 5% water, wherein at least one-third of the caramel flavored confection was cooked at a temperature not less than about 110° C. The water content may be from greater than 5% to about 14% water. In addition, the caramel flavored confection comprises from about 3% to about 20% fat, from about 5% to less than 10% fat, or from about 6% to about 8% fat. The caramel flavored confection comprises from about 12% to about 50% protein, from about 20% to about 45% protein, or from about 28% to about 35% protein.

In one embodiment, the caramel flavored confection is caramel, which contains milk protein. A caramel may be formed by cooking a mixture of sugar and milk protein.

Another embodiment of the caramel flavored confection is taffy, which is aerated. The taffy may or may not be grained. Aerated taffy flavored confections may be made by vigorously mixing a cooked blend of sugar and corn syrup while incorporating air and a second protein. In one embodiment, taffy may be formed by mixing and cooking a sugar, corn syrup and fat, followed by adding a low density frappe to aerate the mixture. This frappe may be a protein source. In the method for making taffy, if a protein is used, it is typically not milk.

Another embodiment of the caramel flavored confection is nougat, which typically does not contain milk, is aerated, and is grained with a short texture. In one embodiment, nougat may be formed by cooking a mixture of sugar and corn syrup to a desired temperature, cooling and vigorously mixing in air, followed by adding protein and fat.

The source of protein may be milk, hydrolyzed gelatin, non-hydrolyzed gelatin, soy protein, whey protein, caseinate, collagens, vegetable protein, fish protein, egg protein, and animal protein. Examples of milk are whole milk, skim milk, 1% milk, 2% milk, evaporated milk, sweetened condensed milk, sweetened condensed skim milk, chocolate milk, powders thereof, and non-fat dry milk.

Dextrose equivalent (DE) is the percent of reducing sugars on a dry basis calculated as dextrose. As familiar to one skilled in the art, glucose (or corn) syrups are formed by reacting a starch with an acid, enzyme, or both. The DE is a measurement of the degree of hydrolysis that starches undergo to yield different sugars. The higher the level of DE in a carbohydrate component, the sweeter the ingredient. A “reducing sugar” is a sugar that can reduce a copper reagent known as Fehlings solution to copper oxide (cuprous oxide). A “non reducing sugar” is a sugar that will not react with the special copper reagent. Sucrose is an example of a common non-reducing sugar. Corn syrups, fructose and milk sugars are examples of reducing sugars. In one embodiment, the dextrose equivalent in the caramel flavored confection is from about 30% to about 50%, or from 0% to about 55%.

One method of making a caramel flavored confection comprises the steps of, homogenizing a mixture comprising water and sugar; cooking the homogenized mixture; and mixing a protein into the cooked mixture; wherein at least one-third of the caramel flavored confection is cooked at not less than about 110° C. The source of the proteins may be liquid or dry. Water may be added to the mixture prior, during, or after heating. When mixing a protein into the cooked mixture, the protein may be added to the cooked mixture, or the cooked mixture may be added to the protein.

In one embodiment, milk is the source of the protein. The homogenized mixture may comprise between about 15% and about 30% water, between about 20% and about 40% sugars, and between about 4% and about 15% milk.

Another method of making a caramel flavored confection comprises the steps of, homogenizing a mixture comprising water, sugar, and a first protein; cooking the homogenized mixture; and mixing a second protein into the cooked mixture; wherein at least one-third of the caramel flavored confection is cooked at not less than about 110° C. The source of the first and second proteins may be the same or different and may be liquid or dry. Water may be added to the mixture prior, during, or after heating. When mixing a second protein into the cooked mixture, the second protein may be added to the cooked mixture, or the cooked mixture may be added to the second protein.

In one embodiment, milk is the source of the first protein. The homogenized mixture may comprise between about 15% and about 30% water, between about 20% and about 40% sugars, and between about 4% and about 15% milk.

The Maillard, Caramelization, or both reactions may occur while the homogenized mixture is being cooked at a temperature of not less than about 110° C. In one embodiment, the homogenized mixture is cooked at a temperature between about 110° C. and about 125° C. In another embodiment, the homogenized mixture is cooked at not less than 110° C., or not less than about 120° C., for about 60 minutes. At least one-third of the caramel flavored confection is cooked. In other embodiments, at least 35%, 40%, 45%, or 50% of the confection is cooked.

In one embodiment, prior to the step of mixing the second protein into the cooked mixture, the protein is mixed with about an equal amount of water by weight, at a temperature between about 50° C. and about 60° C.

In one embodiment for making a caramel flavored confection, after the mixture of water, sugar, and a first protein have been cooked, protein is mixed with the cooked mixture so that the final mixture comprises about 12% to about 50% protein. The final mixture may comprise about 20% to about 35% protein, or about 28% to about 33% protein.

Following the mixing of the second protein with the cooked mixture, the caramel flavored confection may be cooled and used in a process selected from extruding, slab cooling, layering, enrobing, and depositing.

While the present invention has been illustrated by description of several embodiments and while the illustrative embodiments have been described in considerable detail, it is not the intention of the applicant to restrict or in any way limit the scope of the appended claims to such detail. Additional advantages and modifications may readily appear to those skilled in the art.

### EXAMPLE 1

### 30% Protein Caramel

Hydrolyzed gelatin (260 parts) was hydrated in an equal amount of water at 40-95° C. to form a protein mixture. Water (756 parts), crystalline fructose (206 parts), corn syrup (206 parts), non-fat dry milk (199 parts), palm kernel oil (80 parts), lecithin (3.6 parts), salt (3.5 parts), and carrageenan (0.2 parts) were homogenized then cooked at 120° C. with agitation.

The syrup mixture was removed from the heat source and water (200 parts) was added with agitation. Additional colors and flavors were added with agitation. The protein mixture was added to the syrup mixture with agitation and heating. The confection was cooled and extruded.

### EXAMPLE 2

### 49% Protein Caramel

Fructose (135 parts) and dextrose (80 parts) were heated to 77° C. in water (90 parts) until the sugars dissolved. The sugar mixture, hydrolyzed gelatin (123 parts), and palm kernel oil (7.5 parts) were homogenized then cooked at 121° C. with agitation.

The syrup mixture was removed from the heat source and water (80 parts) was added with agitation. Colors, flavors, and sucralose were added with agitation. The mixture was cooled to 71° C. (160 F).

Whey protein isolate (295 parts) and fibersol (14 parts) were mixed for 2 minutes then added to the syrup mixture with continuous high speed mixing. The confection was cooled and extruded.

### EXAMPLE 3

### 20% Protein Caramel

Nonfat dry milk (173 parts), sucrose (383 parts), fructose (143 parts), dextrose (159 parts), palm kernel oil (179 parts), lecithin (3 parts), salt (3 parts), and butter flavor was hydrated with agitation in water (331 parts), and cooked at 118° C. with agitation. The heat source was removed and water (215 parts) was added to the mixture. The mixture was cooked again at 108° C., then cooled. Colors, flavors, and sucralose were added with agitation. The temperature was maintained at 93° C. and whey protein isolate (300 parts) was added with agitation. The confection was cooled and extruded.

### EXAMPLE 4

### 22% Protein Taffy

Sucrose (160 parts), corn syrup (302 parts), vegetable oil (22 parts), glycerol monostearates (7 parts), salt (2 parts), lecithin (2 parts), and water (68 parts) were cooked at 118° C. with agitation. The mixture was cooled to 82° C., and acid, colors, and flavors were added with agitation.

Whey protein isolate (173 parts), and the cooked syrup were mixed with agitation until smooth. The confection was cooled and extruded.

What is claimed is:

1. A caramel flavored confection, comprising from about 12% to about 50% protein and less than 10% fat, wherein at least one-third of the caramel flavored confection was cooked at a temperature not less than about 110° C.

2. A caramel flavored confection of claim 1, wherein the caramel flavored confection is a taffy.

3. A caramel flavored confection of claim 1, wherein the caramel flavored confection is a nougat.

4. A caramel flavored confection of claim 1, wherein the caramel flavored confection is a caramel.

5. A caramel flavored confection of claim 1, wherein the caramel flavored confection comprises from about 20% to about 35% protein.

6. A caramel flavored confection of claim 1, wherein at least some of the milk used in the process to make the caramel flavored confection is selected from whole milk, skim milk, 1% milk, 2% milk, evaporated milk, sweetened condensed milk, sweetened condensed skim milk, chocolate milk, powders thereof, and non-fat dry milk.

7. A caramel flavored confection of claim 1, wherein the caramel flavored confection comprises from about 5% to about 14% water.

8. A caramel flavored confection of claim 1, wherein the dextrose equivalent in the caramel flavored confection is from 0% to about 55%.

9. A caramel flavored confection of claim 1, wherein at least some of the protein used in the process to make the caramel flavored confection is selected from hydrolyzed gelatin, non-hydrolyzed gelatin, soy protein, whey protein, caseinate, collagens, vegetable protein, fish protein, egg protein, and animal protein.

10. A caramel flavored confection comprising from about 12% to about 50% protein and greater than 5% water, wherein at least one-third of the caramel flavored confection was cooked at a temperature not less than about 110° C.

11. A caramel flavored confection of claim 10, wherein the caramel flavored confection is a taffy.

12. A caramel flavored confection of claim 10, wherein the caramel flavored confection is a nougat.

13. A caramel flavored confection of claim 10, wherein the caramel flavored confection is a caramel.

14. A caramel flavored confection of claim 10, wherein the caramel flavored confection comprises from about 20% to about 45% protein.

15. A caramel flavored confection of claim 10, wherein at least some of the milk used in the process to make the caramel flavored confection is selected from whole milk, skim milk, 1% milk, 2% milk, evaporated milk, sweetened condensed milk, sweetened condensed skin milk, chocolate milk, powders thereof, and non-fat dry milk.

16. A caramel flavored confection of claim 10, wherein the caramel flavored confection comprises from about 5% to about 20% fat.

17. A caramel flavored confection of claim 10, wherein the dextrose equivalent in the caramel flavored confection is from 0% to about 55%.

18. A caramel favored confection of claim 10, wherein at least some of the protein used in the process to make the caramel flavored confection is selected from hydrolyzed gelatin, non-hydrolyzed gelatin, soy protein, whey protein, caseinate, collagens, vegetable protein, fish protein, and animal protein.

19. A method of making a caramel flavored confection, comprising the steps of:
homogenizing a mixture comprising water and sugar;
cooking the homogenized mixture; and
mixing a protein into the cooked mixture;
wherein at least one-third of the caramel flavored confection is cooked at a temperature of not less than 110° C.

20. A method of claim 19, wherein the mixture that is homogenized additionally comprises a first protein.

21. A method of claim 20, wherein the mixture comprises between about 15% and about 30% water, between about 20% and about 40% sugar, and between about 4% and about 15% milk.

22. A method of claim 20, wherein the homogenized mixture is cooked at a temperature between about 110° and about 125° C.

23. A method of claim 20, further comprising the step of aerating the mixture, to form a taffy.

24. A nutrition bar comprising the caramel flavored confection of claim 1.

25. A nutrition bar comprising the caramel flavored confection of claim 10.
